(19) United States
(12) Patent Application Publication
(10) Pub. No.: US 2022/0309514 A1
(43) Pub. Date: Sep. 29, 2022

(54) METHOD OF PROVING OWNERSHIP AND OWNERSHIP TRANSFER HISTORY USING DECENTRALIZED ID

(71) Applicant: ELECTRONICS AND TELECOMMUNICATIONS RESEARCH INSTITUTE, Daejeon (KR)

(72) Inventors: Hyun Jin LEE, Daejeon (KR); Dae Geun YOON, Daejeon (KR); Ki Sung PARK, Daejeon (KR)

(21) Appl. No.: 17/704,100

(22) Filed: Mar. 25, 2022

(30) Foreign Application Priority Data
Mar. 26, 2021 (KR) 10-2021-0039872

(51) Int. Cl. G06Q 30/00; H04L 9/08; G06Q 20/38

(52) U.S. Cl. CPC G06Q 30/018; H04L 9/0866; G06Q 20/389; G06Q 2220/145

(57) ABSTRACT

Provided is a method of proving ownership and an ownership transfer history using a decentralized identifier (DID). The method includes identifying, by a verifier terminal, a product through a DID and identifying an initial producer of the product through the DID, generating, by the verifier terminal, a proof-of-ownership verifiable credential (VC) of the product, which includes metadata including information on the VC, security information (claims) including information on a belonging, and issuing organization electronic signature information (proof) including a digital signature method and a signature value for content certification of the VC, and providing, by the verifier terminal, the generated proof-of-ownership VC of the product to the producer of the product and storing a DID document of the produced product in a decentralized external storage in a decentralized manner.

### CROSS-REFERENCE TO RELATED APPLICATION

This application claims priority to and the benefit of Korean Patent Application No. 10-2021-0039872 filed on Mar. 26, 2021, the disclosure of which is incorporated herein by reference in its entirety.

### BACKGROUND

### 1. Field of the Invention

The present invention relates to cryptology, proof of identity, a decentralized identifier (DID), proof of ownership, and a blockchain.

### 2. Description of Related Art

According to general centralized identification methods, a user selects his or her own unique digital identifier (ID) that is easy to remember and then registers the ID and his or her identity information and ownership information (possessions and data) in a central server, and identity authentication and proof of ownership are performed using the registered information.

According to these existing centralized identification methods, a large number of pieces of identity information, such as users' names, birth dates, phone numbers, addresses, email addresses, etc., are stored in a central server. Accordingly, when the central server is exposed to a malicious attack, personal privacy may be violated and overall system stability may be degraded.

Also, according to existing proof-of-ownership systems, a user proves his or her ownership of a product to a verifier through a central server in which the user is registered. Accordingly, when the central server is exposed to an attack or does not work, the user cannot prove his or her ownership of the product.

Therefore, a user has to be able to manage (discard, transfer ownership, sell, etc.) information on possessions by himself or herself without depending on the central server.

“Oracle Blockchain Platform” provides an existing method of proving an ownership transfer history using an external storage, and it is possible to record and track a transaction process of diamonds through the platform.

However, according to “Oracle Blockchain Platform,” users do not sign and prove transactions, and reliable nodes in a private blockchain record transactions in the blockchain to ensure integrity and prove the transactions.

Such a method is only used for simply recording and checking transactions, and thus a technology is necessary for a user to manage and prove an ownership transfer history by himself or herself.

### SUMMARY OF THE INVENTION

The present invention is directed to providing a method of proving ownership and an ownership transfer history using a decentralized identifier (DID) in which a user may manage ownership and an ownership transfer history of a product by himself or herself rather than registering information on his or her product in a central management system and managing the ownership and the ownership transfer history through the central management system.

In other words, the present invention is directed to providing a method for a user to manage (create, delete, transfer, etc.) the ownership of a product and data by himself or herself and prove an ownership transfer history using a DID.

Objects of the present invention are not limited to those described above, and other objects which have not been described will be clearly understood by those of ordinary skill in the art from the following descriptions.

According to an aspect of the present invention, there is provided a method of proving ownership and an ownership transfer history using a DID, the method including identifying, by a verifier terminal, a product through a DID and identifying an initial producer of the product through the DID, generating, by the verifier terminal, a proof-of-ownership verifiable credential (VC) of the product, which includes metadata including information on the VC, security information including information on a belonging, and issuing organization electronic signature information including a digital signature method and a signature value for content certification of the VC, and providing, by the verifier terminal, the generated proof-of-ownership VC of the product to the producer of the product and storing a DID document of the produced product in a decentralized external storage in a decentralized manner.

The decentralized external storage may be at least one of a blockchain network and an InterPlanetary File System (IPFS).

The proof-of-ownership VC may include metadata including various pieces of information on the VC, such as a type, an issuer, a date of issue, etc. of the VC, security information including various pieces of information on the belonging, such as a product DID, an initial producer DID, a production date, a unique product number, etc., and the issuing organization electronic signature information including the digital signature method and the signature value for content certification of the corresponding VC.

The method may further include confirming, by the verifier terminal, the DID of the product through a proof-of-ownership VC of an owner who wants to prove ownership of the product, confirming the DID document information of the product in the decentralized external storage, which stores the DID document information in a decentralized manner, using the confirmed DID of the product when the DID of the product is confirmed, requesting, by the verifier terminal, DID authentication from the owner using a public key recorded in the DID document of the product, and receiving, by the verifier terminal, a response to the DID authentication request from the owner to verify the DID of the product.

The method may further include transmitting, by a purchaser terminal, DID information or public key information of a purchaser to a seller, additionally including, by a seller terminal, a proof-of-ownership transfer history VC, in which a public key in the DID document of the product corresponding to the DID of the product is changed to the public key of the purchaser, in the proof-of-ownership VC and storing the proof-of-ownership VC in the decentralized external storage, providing, by the seller terminal, a response notifying that a change of the public key in the DID document of the product is completed to the purchaser, and accessing, by the purchaser terminal, the decentralized external storage to confirm the DID document of the product.

The proof-of-ownership VC of the product may include metadata which is a data layer including various pieces of information on the VC, such as a type, an issuer, a date of issue, etc. of the VC, security information which is a data layer including an identifier (ID) of the proof-of-ownership VC of the product, a DID of an owner (the purchaser), and a DID document version time at a time of transaction, and issuing organization electronic signature information including a digital signature method and the signature value for content certification of the VC.

The method may further include issuing, by the initial seller, the proof-of-ownership VC and the proof-of-ownership transfer history VC, in which ownership has been transferred, to the initial purchaser terminal, determining, by the initial purchaser terminal, whether an ID of the proof-of-ownership transfer history VC is identical to a security information ID of the proof-of-ownership VC of the product, when the ID of the proof-of-ownership transfer history VC differs from the security information ID of the proof-of-ownership VC of the product, confirming a DID document version time of the proof-of-ownership transfer history VC and then confirming public key information of a DID document corresponding to the DID, and verifying the issuing organization electronic signature information using a public key of the initial seller in the DID document at the time of transaction.

The method may further include, after the verifying of the issuing organization electronic signature information using the public key of the initial seller of the DID document at the time of transaction, determining whether there is a previously generated proof-of-ownership transfer history VC and, when it is determined that there is a previously generated proof-of-ownership transfer history VC, verifying the validity of the proof-of-ownership transfer history VC and the previously generated proof-of-ownership transfer history VC to repeat integrity verification of the proof-of-ownership transfer history.

A user terminal of the product may access the decentralized external storage, which manages data in a decentralized manner, to record data which indicates deletion or disposal of a public key in the DID document of the product corresponding to the DID of the product.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a method of proving ownership and an ownership transfer history using a decentralized identifier (DID) according to the present invention;

FIG. 2 is a flowchart illustrating a method of generating a proof-of-ownership verifiable credential (VC) in the method of proving ownership and an ownership transfer history using a DID according to the exemplary embodiment of the present invention;

FIG. 3 is a reference drawing illustrating a structure of a proof-of-ownership VC according to an exemplary embodiment of the present invention;

FIG. 4 is a sequence diagram illustrating a method of verifying the ownership of a product in the method of proving ownership and an ownership transfer history using a DID according to the exemplary embodiment of the present invention;

FIG. 5 is a sequence diagram illustrating a DID-based product ownership transfer technique in the method of proving ownership and an ownership transfer history using a DID according to the exemplary embodiment of the present invention;

FIG. 6 is a sequence diagram illustrating a method of proving a product ownership transfer history on the basis of a DID in the method of proving ownership and an ownership transfer history using a DID according to the exemplary embodiment of the present invention;

FIG. 7 is a reference diagram illustrating a structure of a proof-of-ownership transfer history VC according to an exemplary embodiment of the present invention; and

FIG. 8 is a reference diagram illustrating a DID-based product ownership transfer history tracking technique according to an exemplary embodiment of the present invention.

### DETAILED DESCRIPTION OF EXEMPLARY EMBODIMENTS

Advantages and features of the present invention and methods for accomplishing the same will become apparent from exemplary embodiments described in detail below with reference to the accompanying drawings. However, the present invention is not limited to the exemplary embodiments set forth herein and may be implemented in various different forms. The exemplary embodiments are provided only to make disclosure of the present invention complete and to fully convey the scope of the invention to those skilled in the technical field to which the present invention pertains, and the present invention is only defined by the claims. Meanwhile, terms used in this specification are for describing the exemplary embodiments rather than limiting the present invention. In this specification, singular forms include plural forms unless expressly stated otherwise. As used herein, the term “comprises” and/or “comprising” does not preclude the presence or addition of one or more components, steps, operations and/or devices other than stated components, steps, operations and/or devices.

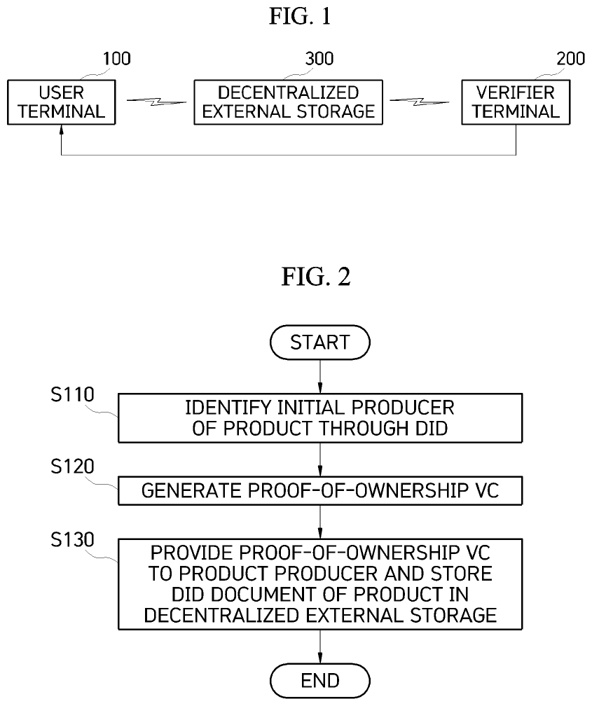

FIG. 1 is a block diagram illustrating a method of proving ownership and an ownership transfer history using a decentralized identifier (DID) according to the present invention.

As shown in FIG. 1, a system for performing the method of proving ownership and an ownership transfer history using a DID according to an exemplary embodiment of the present invention includes a user terminal 100, a verifier terminal 200, and a decentralized external storage 300.

A proof-of-ownership verifiable credential (VC) of a product and a wallet application or wallet program for storing or deleting a proof-of-ownership transfer history VC are installed on the user terminal 100. The user terminal 100 performs self-authentication through login and then accesses the decentralized external storage 300. Then, an owner may change the history of a DID document of a product stored in the decentralized external storage 300 through the user terminal 100 in which self-authentication has been performed through login.

The owner logs in to the user terminal 100, on which the DID wallet application is installed, through self-authentication and then requests an issuer to issue identity information so as to receive a DID. Then, the issuer verifies the identity of the owner and then issues identity information to the user terminal 100 to which the owner has logged in, and the identify information issued by the issuer is stored in the electronic wallet installed on the user terminal 100. Subsequently, the owner may be authenticated by providing the identity information stored in his or her electronic wallet to the verifier terminal 200 (a service provider).

Meanwhile, the DID issuer issues the identity information after verifying the identity of the owner and then stores verification information for issuing the identity information of the owner in the decentralized external storage 300.

The verifier logs in to the verifier terminal 200 on which a program or application for accessing the decentralized external storage 300 is installed. When the owner provides the identity information through the electronic wallet, the verifier may confirm the verification information for issuing the identify information stored in the decentralized external storage 300 and verify the identity information of the owner.

Accordingly, the verifier logs in to the program or application installed on the verifier terminal 200. Subsequently, the verifier may confirm the identity information (a DID) provided by the owner through the verifier terminal 200, access the decentralized external storage 300 using the confirmed identity information (the DID) of the owner, and authenticate the DID of the owner using a public key recorded in detailed identity information (DID document information) of the owner.

In this exemplary embodiment, DIDs may be used not only for identity information of owners but also for identity information of products.

As the decentralized external storage 300, a blockchain network in which data is stored in a decentralized manner in nodes distributed over an online network or an InterPlanetary File System (IPFS) is used. DID documents of products are stored in a decentralized manner in the nodes of the blockchain.

A method of generating a proof-of-ownership VC in the method of proving ownership and an ownership transfer history using a DID according to the exemplary embodiment of the present invention will be described below with reference to FIG. 2.

The verifier terminal 200 identify an initial producer of a product using a DID (S110). At this time, the product may be identified using the DID. The DID is a string for identifying an individual, an institution, or a device and is fixed as a technology provider, an arbitrary string, or a DID.

Subsequently, the verifier terminal 200 generates a proof-of-ownership VC of the product including metadata including information on the VC, security information (claims) including information on a belonging, and issuing organization electronic signature information (proof) including a digital signature method and a signature value for content certification of the VC (S120). DID information of the product may be stored in the security information.

Subsequently, the verifier terminal 200 provides the generated proof-of-ownership VC of the product to the producer of the product and stores a generated DID document of the product in the decentralized external storage 300 (S130). The DID document is public information which is registered in a blockchain in the form of a JavaScript Object Notation (JSON) file and includes information, such as a DID of the producer, a public key, an authentication method, an electronic signature of the producer, etc.

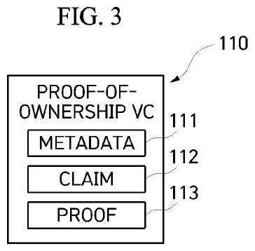

Meanwhile, as shown in FIG. 3, a proof-of-ownership VC 110 has a structure including metadata 111, security information 112, and issuing organization electronic signature information 113.

Metadata 111 includes various pieces of information on the VC 110, such as a type, an issuer, a date of issue, etc.

The security information (claims) 112 includes various pieces of information of a belonging, such as a product (data) DID, an initial producer DID, a production date, a unique product number, etc. The security information necessarily includes a product DID.

The issuing organization electronic signature information (proof) 113 includes a digital signature method, such as a Rivest-Shamir-Adleman (RSA) algorithm, an elliptic curve digital signature algorithm (ECDSA), a Camenisch-Lysyanskaya (CL) signature, etc., and a signature value for content certification of the VC 110.

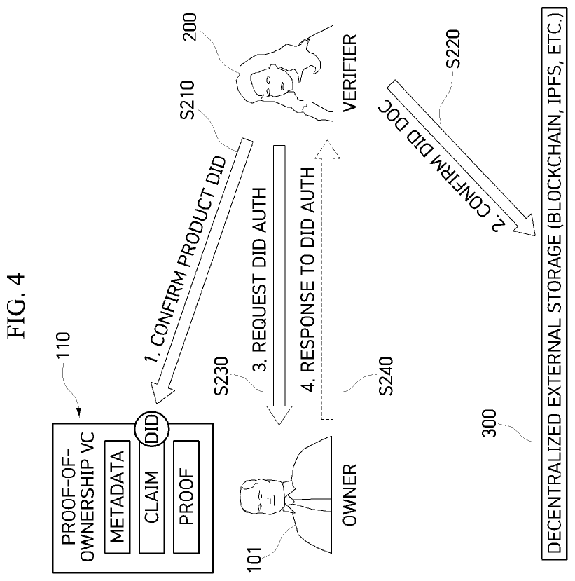

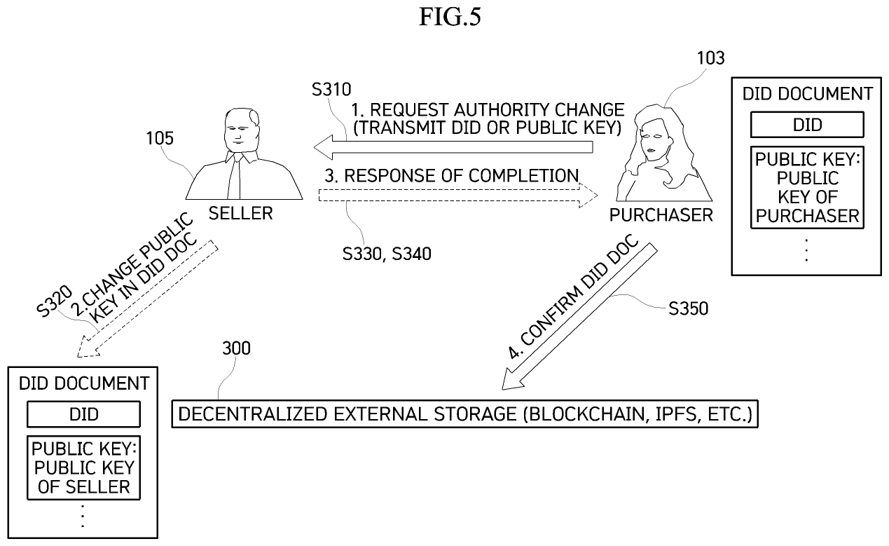

A method of verifying the ownership of a product in the method of proving ownership and an ownership transfer history using a DID according to the exemplary embodiment of the present invention will be described with reference to FIG. 4.

First, the verifier terminal 200 confirms a DID of a product from a proof-of-ownership VC 110 stored in an owner terminal 101 (S210).

Subsequently, when the DID of the product for which a proof-of-ownership is to be verified is confirmed, the verifier terminal 200 confirms DID document information of the product from the decentralized external storage 300 using the confirmed DID of the product (S220).

Then, the verifier terminal 200 requests an owner to perform owner DID authentication using a public key recorded in the DID document of the product (S230).

Subsequently, the verifier terminal 200 receives a response to the DID authentication from the owner, thereby completing proof-of-ownership of the product (S240).

TABLE 1
DID Document

[symbol]

```
  { [symbol]
  ″@context″: ″https://www.w3.org/ns/did/v1″, [symbol]
  ″id″: ″did:example:123456789abcdefghi″, [symbol]
  ″authentication″: [{ [symbol]
  // used to authenticate as [symbol] [symbol]
  ″id″: ″did:example:123456789abcdefghi#keys-1″, [symbol]
  ″type″: ″Ed25519VerificationKey2018″, [symbol]
  ″controller″: ″did:example:123456789abcdefghi″, [symbol]
  ″publicKeyBase58″: ″H3C2AVvLMv6gmMNam3uVAjZpfkcJCwDwnZn6z3wXmqPV [symbol]   ], [symbol]
  ″service″: [{ [symbol]
  // used to retrieve Verifiable Credentials associated with the DID [symbol]
  ″id″:″did:example:123456789abcdefghi#vcs″, [symbol]
  ″type″: ″ [symbol]   ″, [symbol]
  ″ [symbol]   ″: ″https://example.com/ [symbol]   / [symbol]   ] [symbol]
}

[symbol]

[symbol]

```

[Table 1] is a table showing an example of a World Wide Web Consortium (W3C) DID document.

A DID-based product ownership transfer technique in the method of proving ownership and an ownership transfer history using a DID according to the exemplary embodiment of the present invention will be described below with reference to FIG. 5.

First, a purchaser terminal 103 transmits DID information or public key information of a purchaser to a seller (S310).

Then, a seller terminal 105 changes a public key, which corresponds to a DID of a product and is present in a DID document of the product stored in a decentralized manner in the decentralized external storage 300, to the public key of the purchaser (S320).

Also, the seller terminal 105 generates a proof-of-ownership transfer history VC in addition to a currently held proof-of-ownership VC (S330) and then provides a response notifying that a change of the public key in the DID document of the product is completed to the purchaser (S340).

Subsequently, the purchaser terminal 103 accesses the decentralized external storage 300 and confirms the DID document of the product, thereby completing a DID-based product ownership transfer (S350).

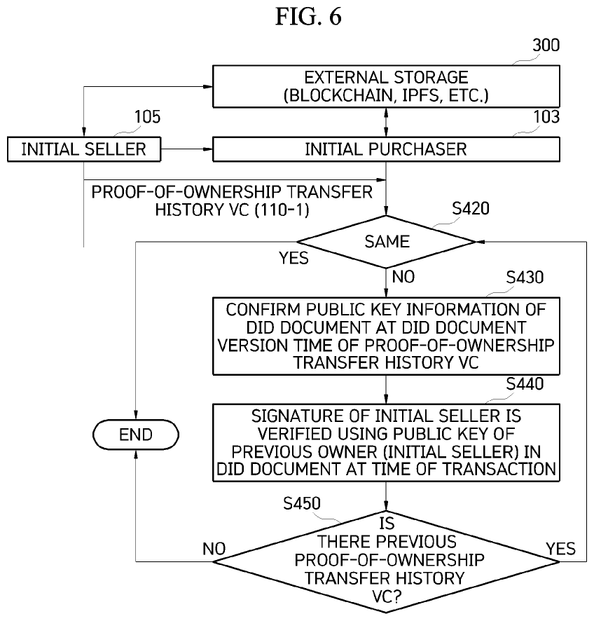

A method of proving a product ownership transfer history on the basis of a DID in the method of proving ownership and an ownership transfer history using a DID according to the exemplary embodiment of the present invention will be described with reference to FIG. 6.

First, an initial seller who has a proof-of-ownership VC 110 issues a proof-of-ownership transfer history VC 110-1, in which ownership has been transferred from the initial seller, to an initial purchaser terminal 103 (S410).

Subsequently, the initial purchaser terminal 103 determines whether an identifier (ID) of the proof-of-ownership transfer history VC 110-1 is identical to an ID of security information of the proof-of-ownership VC 110 of a product (S420).

When the ID of the proof-of-ownership transfer history VC 110-1 differs from the ID of the security information (claims) of the proof-of-ownership VC 110 (NO), public key information of a DID document is confirmed at a DID document version time of the proof-of-ownership transfer history VC 110-1 (S430).

Subsequently, a proof (a signature of the initial seller) is verified using a public key of the initial seller in the DID document at the time of transaction (S440).

Meanwhile, after the operation of verifying the proof (the signature of the initial seller) using the public key of the initial seller in the DID document at the time of transaction (S440), it is determined whether there is a previously generated proof-of-ownership transfer history VC 110-1 (S450).

When it is determined in the determination operation S450 that there is a previously generated proof-of-ownership transfer history VC 110-1, the validity of the proof-of-ownership transfer history VC 110-1 and the previous proof-of-ownership transfer history VC 110-1 is verified. In this way, the integrity of an ownership transfer history is repeatedly verified until there is no previously generated proof-of-ownership transfer history VC 110-1.

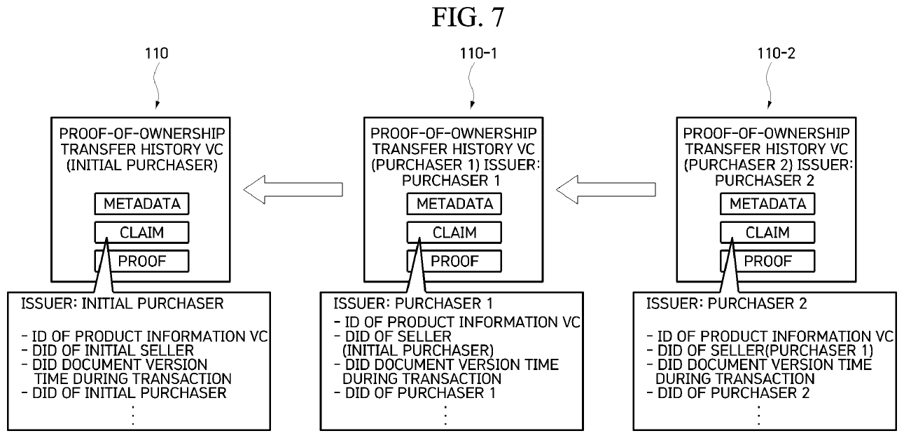

Here, as shown in FIG. 7, in a proof-of-ownership transfer history VC 110, an issuer is an initial purchaser, and information including a product information VC ID, an initial seller DID, a DID document version time at the time of transaction, an initial purchaser DID, etc. is included. Also, in a proof-of-ownership transfer history VC 110-1, an issuer is Purchaser 1, and information including the product information VC ID, a seller (the initial purchaser) DID, a DID document version time at the time of transaction, a Purchaser 1 DID, etc. is included.

When there is another proof-of-ownership transfer history, as shown in a proof-of-ownership transfer history VC 110-2, an issuer may be Purchaser 2, and information including the product information VC ID, a seller (Purchaser 1) DID, a DID document version time at the time of transaction, a Purchaser 2 DID, etc. may be included.

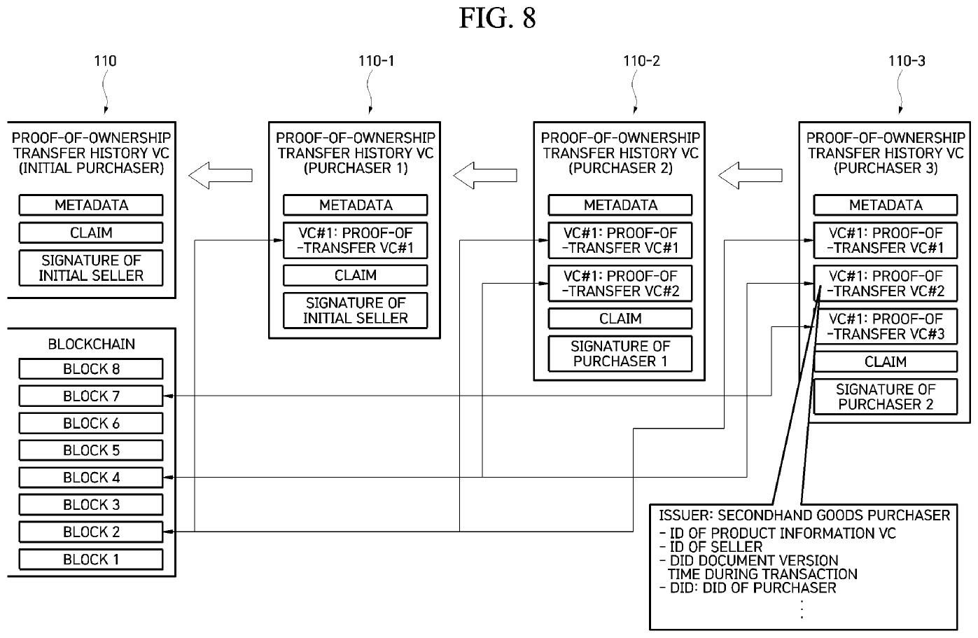

On the other hand, as shown in FIG. 8, proof-of-ownership transfer history VCs 110, 110-1, 110-2, and 110-3 according to an exemplary embodiment of the present invention may include metadata, security information, a proof-of-transfer history VC in the case of a transfer, and an issuing organization electronic signature information (proof).

The metadata includes various pieces of information on the corresponding VC, such as a type, an issuer, a date of issue, etc.

The security information (claims) includes various pieces of information of a belonging, such as a product (data) DID, an initial producer DID, a production date, a unique product number, etc. The security information necessarily includes a product DID.

The proof-of-transfer history VC is generated by a seller every time the ownership of the product is transferred and includes various pieces of information, such as an ID of the proof-of-ownership VC 110 of the product, an owner (purchaser) DID, a DID document version time (Block #, timestamp) at the time of transaction, etc. The proof-of-transfer history VC necessarily includes the DID of the product for proving ownership.

The issuing organization electronic signature information (proof) includes a digital signature method, such as the RSA algorithm, ECDSA, CL signature, etc., and a signature value for content certification of the corresponding VC.

A method of discarding a product in the method of proving ownership and an ownership transfer history using a DID according to the exemplary embodiment of the present invention will be described below.

To this end, a user terminal 100 of a product may record data which indicates the deletion or disposal of a public key in a DID document of a product corresponding to a DID of the product, thereby completing product disposal.

According to an exemplary embodiment of the present invention, a user can perform management of ownership information rights, proof of an ownership transfer history, etc. Accordingly, even when a central server is attacked, it is possible to ensure the ownership of a product and prove an ownership transfer history.

Each step included in the method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Although a configuration of the present invention has been described in detail with reference to the accompanying drawings, this is just an example, and those skilled in the technical field to which the present invention pertains can make various modifications and alterations within the technical spirit of the present invention. Therefore, the scope of the present invention is not limited to the exemplary embodiments described above and should be defined by the following claims.

What is claimed is:

1. A method of proving ownership and an ownership transfer history using a decentralized identifier (DID), the method comprising:
identifying, by a verifier terminal, a product through a DID and identifying an initial producer of the product through the DID;
generating, by the verifier terminal, a proof-of-ownership verifiable credential (VC) of the product, which includes metadata including information on the VC, security information including information on a belonging, and issuing organization electronic signature information including a digital signature method and a signature value for content certification of the VC; and
providing, by the verifier terminal, the generated proof-of-ownership VC of the product to the producer of the product and storing a DID document of the produced product in a decentralized external storage in a decentralized manner.

2. The method of claim 1, wherein the decentralized external storage is a blockchain network.

3. The method of claim 1, wherein the decentralized external storage is an InterPlanetary File System (IPFS).

4. The method of claim 1, wherein the proof-of-ownership VC includes:
metadata including various pieces of information on the VC, such as a type, an issuer, a date of issue, etc. of the VC;
security information including various pieces of information on the belonging, such as a product DID, an initial producer DID, a production date, a unique product number, etc.; and
issuing organization electronic signature information including the digital signature method and the signature value for content certification of the corresponding VC.

5. The method of claim 1, further comprising:
confirming, by the verifier terminal, the DID of the product through a proof-of-ownership VC of an owner who wants to prove ownership of the product;
confirming, by the verifier terminal, the DID document information of the product in the decentralized external storage, which stores the DID document information in a decentralized manner, using the confirmed DID of the product when the DID of the product is confirmed;
requesting, by the verifier terminal, DID authentication from the owner using a public key recorded in the DID document of the product; and
receiving, by the verifier terminal, a response to the DID authentication request from the owner to verify the DID of the product.

6. The method of claim 1, further comprising:
transmitting, by a purchaser terminal, DID information or public key information of a purchaser to a seller;
additionally including, by a seller terminal, a proof-of-ownership transfer history VC, in which a public key in the DID document of the product corresponding to the DID of the product is changed to the public key of the purchaser, in the proof-of-ownership VC and storing the proof-of-ownership VC in the decentralized external storage;
providing, by the seller terminal, a response notifying that a change of the public key in the DID document of the product is completed to the purchaser, and
accessing, by the purchaser terminal, the decentralized external storage to confirm the DID document of the product.

7. The method of claim 6, wherein the proof-of-ownership VC of the product includes:
metadata which is a data layer including various pieces of information on the VC, such as a type, an issuer, a date of issue, etc. of the VC;
security information which is a data layer including various pieces of information including an identifier (ID) of the proof-of-ownership VC of the product, a DID of an owner, and a DID document version time at a time of transaction; and
issuing organization electronic signature information including a digital signature method and the signature value for content certification of the VC.

8. The method of claim 7, further comprising:
issuing, by the initial seller, the proof-of-ownership VC and the proof-of-ownership transfer history VC, in which ownership has been transferred, to the initial purchaser terminal;
determining, by the initial purchaser terminal, whether an ID of the proof-of-ownership transfer history VC is identical to a security information ID of the proof-of-ownership VC of the product;
when the ID of the proof-of-ownership transfer history VC differs from the security information ID of the proof-of-ownership VC of the product, confirming a DID document version time of the proof-of-ownership transfer history VC and then confirming public key information of a DID document corresponding to the DID; and
verifying the issuing organization electronic signature information using a public key of the initial seller of the DID document at the time of transaction.

9. The method of claim 5, further comprising, after the verifying of the issuing organization electronic signature information using the public key of the initial seller of the DID document at the time of transaction:
determining whether there is a previously generated proof-of-ownership transfer history VC; and
when it is determined that there is a previously generated proof-of-ownership transfer history VC, verifying validity of the proof-of-ownership transfer history VC and the previously generated proof-of-ownership transfer history VC to repeat integrity verification of the proof-of-ownership transfer history.

10. The method of claim 1, wherein the user terminal of the product accesses the decentralized external storage, which manages data in a decentralized manner, to record data which indicates deletion or disposal of a public key in the DID document of the product corresponding to the DID of the product.
